(19) United States
(12) Patent Application Publication
(10) Pub. No.: US 2026/0048440 A1
(43) Pub. Date: Feb. 19, 2026

(54) SELF-CENTERING DRILL ASSEMBLY

(71) Applicant: Jesse Jaramillo, Beaumont, CA (US)

(72) Inventor: Jesse Jaramillo, Beaumont, CA (US)

(21) Appl. No.: 18/803,328

(22) Filed: Aug. 13, 2024

(51) Int. Cl. B23B 49/04

(52) U.S. Cl. CPC B23B 49/04

(57) ABSTRACT

A self-centering drill assembly includes a drill bit, a chuck adapter, a sleeve, a stop ring, a spring, and a slide ring. The chuck adapter is elongated and includes a first adapter end connected to the drill bit, a second adapter end insertable into a drill chuck, and a shaft connecting the first and second adapter ends. The sleeve includes a first sleeve end slidably mounted on the shaft and a second sleeve end that is tapered and includes an orifice. The stop ring is positioned at the second adapter end. The spring is positioned between the stop ring and an interior surface of the second sleeve end to provide a biasing force to push the sleeve away from the chuck adapter. The slide ring is positioned at the first sleeve end and is configured to guide the sleeve along the shaft and abut against the stop ring.

### (b) CROSS-REFERENCE TO RELATED APPLICATIONS

Not Applicable (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to drilling tools and more particularly pertains to a new self-centering drill assembly for providing an improved way to center drill holes for drilling pilot holes for hinges, drawer glides, and hardware with countersunk holes, such as for use in cabinet building and many other trades.

### (2) Description of Related Art Including Information Disclosed Under 37 CFR 1.97 and 1.98

The prior art relates to drilling tools. The prior art, as best understood, does not disclose a drill bit with a centering guide that is comprised of a drill bit with a cylindrical sleeve with a tapered end piece which encircles the drill bit and contains an internal coil spring which allows the drill bit to extend past the sleeve member when pressure is exerted on the drill bit.

### (h) BRIEF SUMMARY OF THE INVENTION

An embodiment of the disclosure meets the needs presented above in a self-centering drill assembly generally comprising a drill bit, a chuck adapter, a sleeve, a stop ring, a spring, and a slide ring. The chuck adapter is elongated and includes a first adapter end insertable into a drill chuck, a second adapter end connected to the drill bit, and a shaft connecting the first and second adapter ends. The sleeve includes a first sleeve end slidably mounted on the shaft and a second sleeve end that is tapered and includes an orifice through which the drill bit is inserted. The stop ring is positioned at the second adapter end. The spring is positioned between the stop ring and an interior surface of the second sleeve end to provide a biasing force to push the sleeve away from the chuck adapter. The slide ring is positioned at the first sleeve end and is configured to guide the sleeve along the shaft and abut against the stop ring to prevent dislodging of the sleeve from the chuck adapter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a self-centering drill assembly according to an embodiment of the disclosure.

FIG. 2 is a perspective view of an embodiment of the disclosure.

FIG. 3 is an exploded view of an embodiment of the disclosure.

FIG. 4 is an exploded view of an embodiment of the disclosure.

FIG. 5 is an exploded view of an embodiment of the disclosure.

FIG. 6 is a cross-sectional view of an embodiment of the disclosure.

FIG. 7 is a cross-sectional view of an embodiment of the disclosure.

FIG. 8 is a view of an embodiment of the disclosure in use.

FIG. 9 is a view of an embodiment of the disclosure in use.

FIG. 10 is a cross-sectional view of another embodiment of the disclosure

### (j) DETAILED DESCRIPTION OF THE INVENTION

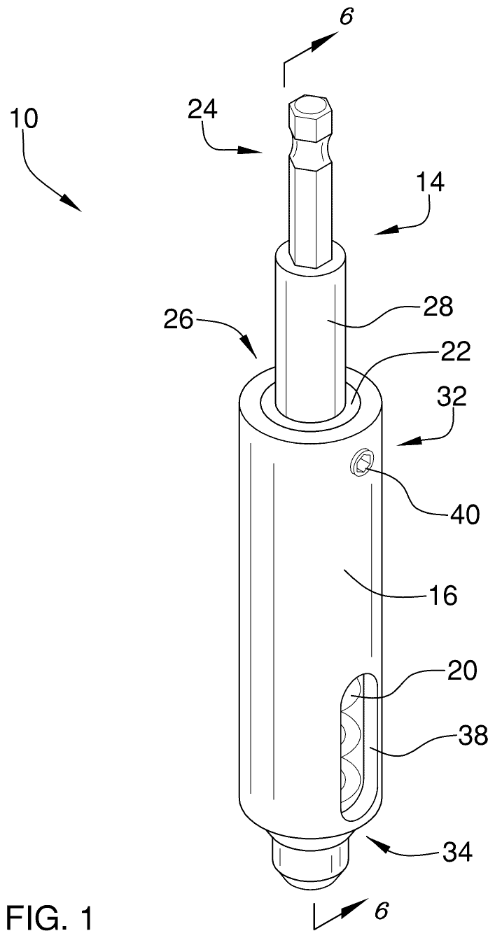

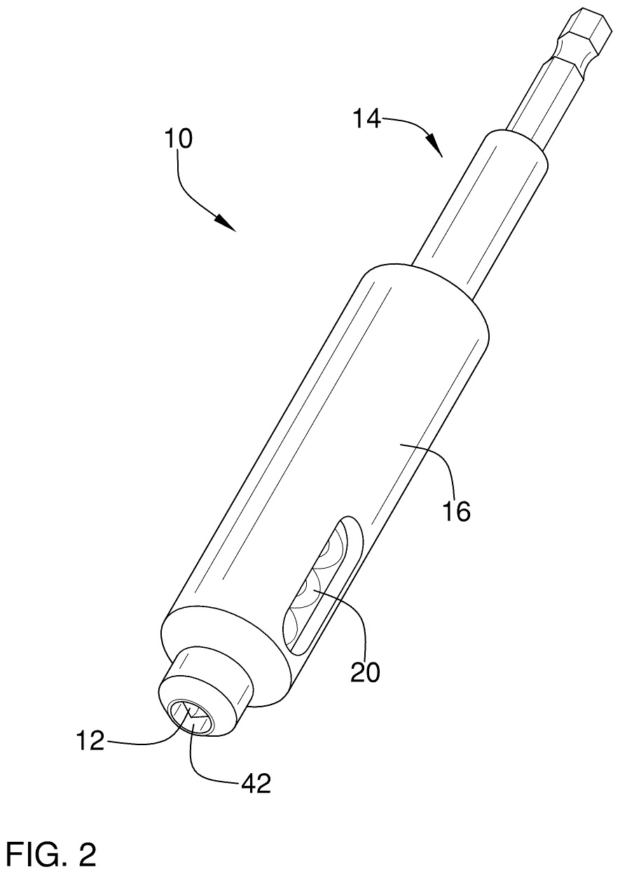

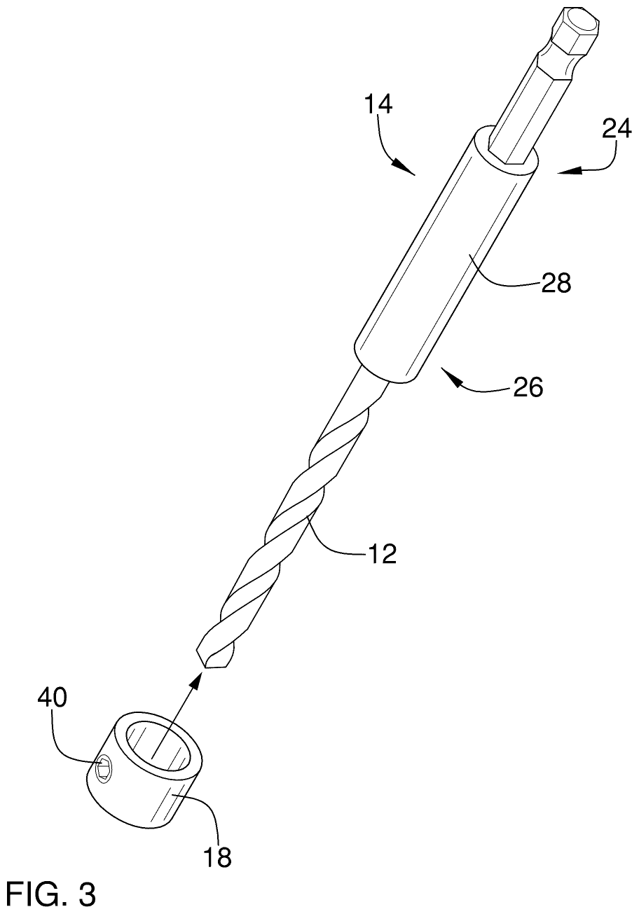

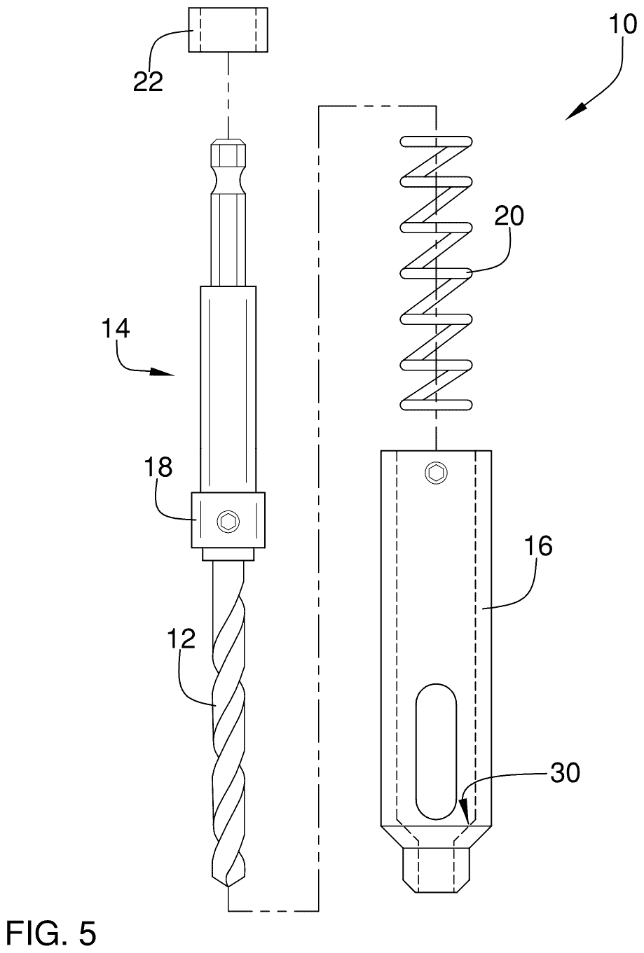

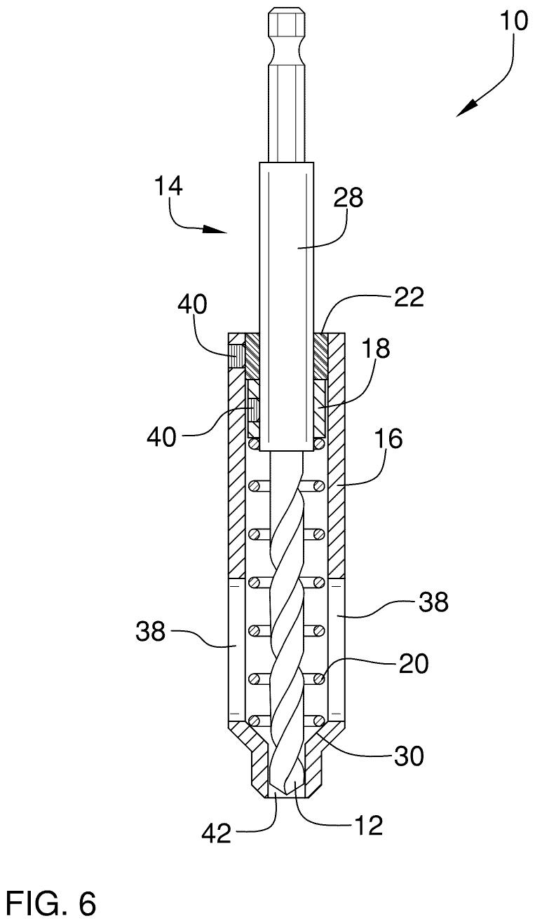

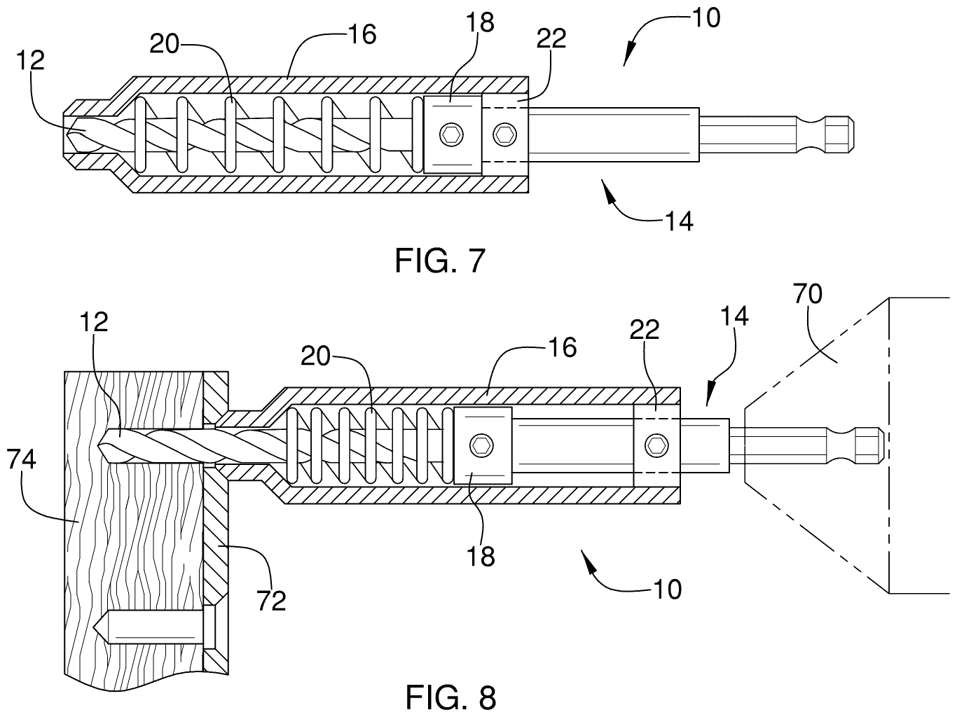

With reference now to the drawings, and in particular to FIGS. 1 through 10 thereof, a new self-centering drill assembly embodying the principles and concepts of an embodiment of the disclosure and generally designated by the reference numeral 10 will be described.

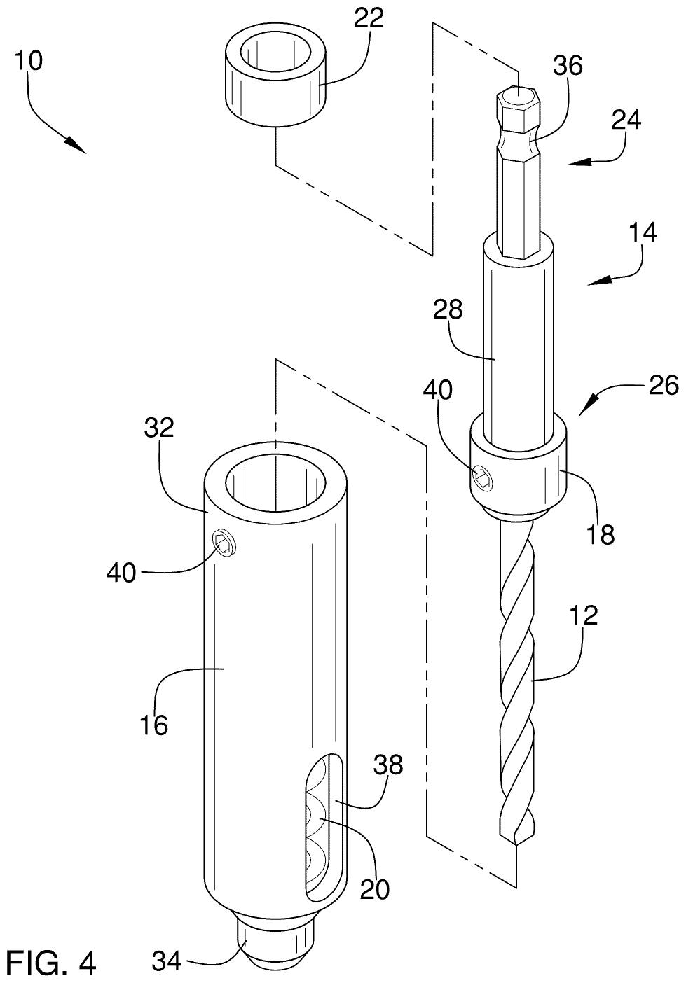

As best illustrated in FIGS. 1 through 10, the self-centering drill assembly 10 generally comprises a drill bit 12, a chuck adapter 14, a sleeve 16, a stop ring 18, a spring 20, and a slide ring 22. As best seen in FIGS. 4, 5, and 6, the chuck adapter 14 is elongated and includes a first adapter end 24 insertable into a drill chuck, a second adapter end 26 connected to the drill bit 12, and a shaft 28 connecting the first and second adapter ends 24, 26. The sleeve 16 includes a first sleeve end 32 slidably mounted on the shaft 28 and a second sleeve end 34 that is tapered and includes an orifice 42 through which the drill bit 12 is inserted. The stop ring 18 is positioned at the second adapter end 26. The spring 20 is positioned between the stop ring 18 and an interior surface 30 of the second sleeve end 34 to provide a biasing force to push the sleeve 16 away from the chuck adapter 14. The slide ring 22 is positioned at the first sleeve end 32 and is configured to guide the sleeve 16 along the shaft 28 and abut against the stop ring 18 to prevent dislodging of the sleeve 16 from the chuck adapter 14.

In the exemplary embodiment, the first adapter end 24 includes an indented end 36 configured to permit quick connection and release with a drill chuck, though other connection styles known in the drill arts are within the scope of the disclosure. The sleeve 16 includes a dust port 38, or possibly two or more as shown in the exemplary embodiment.

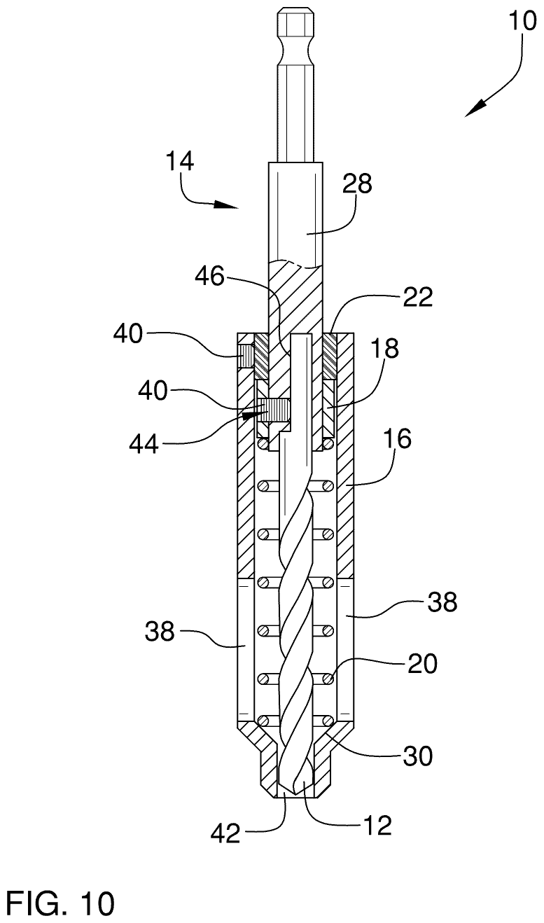

In the exemplary embodiment, the stop ring 18 is detachably connected to the second adapter end 26. The stop ring 18 includes a set screw 40 to detachably connect the stop ring 18 to the second adapter end 26, though other detachable connections are within the scope of the disclosure. The stop ring 18 is selectively positionable and attachable along the shaft 28. Alternatively, the stop ring 18 could be permanently attached to the shaft 28, such as by adhesive or welding, or could be integrally formed as part of the shaft 28, to form essentially a one-piece structure. The stop ring 18 is made of steel, but could also be made of plastic, other metals, or combinations thereof. In one possible embodiment shown in FIG. 10, the second adapter end 26 comprises a portal 44 therein and the drill bit 12 comprises a flattened shaft portion 46, wherein the set screw 40 is inserted through the portal 44 and engages the flattened shaft portion 46 to detachably secure the drill bit 12 in the second adapter end 26.

In one possible embodiment, the spring 20 is attached to the stop ring 18, though in another possible embodiment the spring 20 could be freely held inside the sleeve 16.

The slide ring 22 is detachably connected to and positioned within the first sleeve end 32. The first sleeve end 32 includes a set screw 40 to detachably connect the first sleeve end 32 to the slide ring 22, though other detachable connections are within the scope of the disclosure. The slide ring 22 is made of steel, but could also be made of plastic, other metals, or combinations thereof.

In one possible embodiment, the self-centering drill assembly 10 includes a plurality of the drill bits 12 and the chuck adapters 14 to essentially form a kit of common drill bits 12 wherein the drill bits 12 are of different diameters, such as 1/16 inch, 3/32 inch, ⅛ inch, and 5 mm, or possibly other sizes. The drill bits 12 must be smaller than the orifice 42 in the second sleeve end 34 as the chuck adapters 14 are each identical to permit removable attachment of the stop ring 18, the slide ring 22, the sleeve 16, and the spring 20.

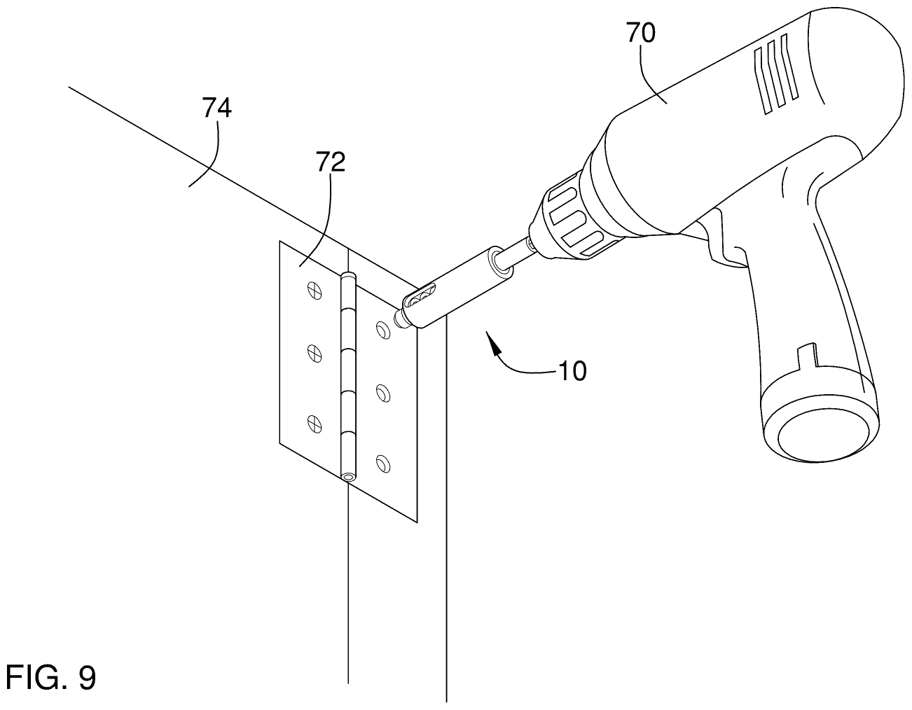

To use the self-centering drill assembly 10, the user inserts the chuck adapter 14 into a power drill 70. As shown in FIG. 9, the user then places the second sleeve end 34 against a countersunk portion of a countersunk hole or a plate of a structure, such as a door hinge 72 as shown, which centers the sleeve 16 and thus the drill bit 12. As shown in FIG. 8, the user then begins drilling and pressing the second sleeve end 34 against the object, which force causes the sleeve 16 to be moved axially against the biasing force of the spring 20, which compresses the spring 20 and causes the sleeve 16 to slide via the slide ring 22 along the shaft 28 to expose the drill bit 12 to allow drilling into wood 74 or a similar object. When done, the user removes the drill bit 12 and the spring 20 pushes the sleeve 16 along the shaft 28 until the slide ring 22 abuts the stop ring 18, as shown in FIG. 8. In the case of a self-centering drill assembly 10 kit, the user disconnects the slide ring 22, removes the sleeve 16, and disconnects the stop ring 18 and removes the stop ring 18 and spring 20 from a first drill bit 12 and chuck adapter 14, and then reconnects those components to a second, different, drill bit 12 attached to a chuck assembly of similar or identical design.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A self-centering drill assembly comprising:
a drill bit;
a chuck adapter being elongated and comprising a first adapter end insertable into a drill chuck, a second adapter end connected to said drill bit, and a shaft connecting said first and second adapter ends;
a sleeve comprising a first sleeve end slidably mounted on said shaft and a second sleeve end being tapered and comprising an orifice through which said drill bit is inserted;
a stop ring disposed at said second adapter end;
a spring disposed between said stop ring and an interior surface of said second sleeve end to provide a biasing force to push said sleeve away from said chuck adapter; and
a slide ring disposed at said first sleeve end and configured to guide said sleeve along said shaft and abut against said stop ring to prevent dislodging of said sleeve from said chuck adapter.

2. The self-centering drill assembly of claim 1, wherein said first adapter end comprises an indented end configured to permit quick connection and release with a drill chuck.

3. The self-centering drill assembly of claim 1, wherein said stop ring is detachably connected to said second adapter end.

4. The self-centering drill assembly of claim 3, wherein said stop ring comprises a set screw to detachably connect said stop ring to said second adapter end.

5. The self-centering drill assembly of claim 3, wherein said stop ring is selectively positionable and attachable along said shaft.

6. The self-centering drill assembly of claim 1, wherein said stop ring comprises steel.

7. The self-centering drill assembly of claim 1, wherein said stop ring comprises plastic.

8. The self-centering drill assembly of claim 1, wherein said spring is attached to said stop ring.

9. The self-centering drill assembly of claim 1, wherein said slide ring is detachably connected to and disposed within said first sleeve end.

10. The self-centering drill assembly of claim 1, wherein said first sleeve end comprises a set screw to detachably connect said first sleeve end to said slide ring.

11. The self-centering drill assembly of claim 1, wherein said slide ring comprises steel.

12. The self-centering drill assembly of claim 1, wherein said slide ring comprises plastic.

13. The self-centering drill assembly of claim 1, wherein said sleeve comprises a dust port.

14. The self-centering drill assembly of claim 1, wherein the self-centering drill assembly comprises a plurality of said drill bits and said chuck adapters, wherein said drill bits are of different diameters smaller than said orifice in said second sleeve end and said chuck adapters are each identical to permit removable attachment of said stop ring, said slide ring, said sleeve, and said spring.

15. The self-centering drill assembly of claim 4, wherein said second adapter end comprises a portal therein and said drill bit comprises a flattened shaft portion, wherein said set screw is inserted through said portal and engages said flattened shaft portion to detachably secure said drill bit in said second adapter end.

16. A self-centering drill assembly comprising:
a drill bit;
a chuck adapter being elongated and comprising a first adapter end connected to said drill bit, a second adapter end insertable into a drill chuck, and a shaft connecting said first and second adapter ends, wherein said second adapter end comprises an indented end configured to permit quick connection and release with a drill chuck;
a sleeve comprising a first sleeve end slidably mounted on said shaft and a second sleeve end being tapered and comprising an orifice through which said drill bit is inserted, wherein said sleeve comprises a dust port;
a stop ring disposed at said second adapter end, wherein:
said stop ring is detachably connected to said second adapter end,
said stop ring comprises a set screw to detachably connect said stop ring to said second adapter end,
said stop ring is selectively positionable and attachable along said shaft,
said stop ring comprises steel or plastic,
a spring disposed between said stop ring and an interior surface of said second sleeve end to provide a biasing force to push said sleeve away from said chuck adapter, wherein said spring is attached to said stop ring; and
a slide ring disposed at said first sleeve end and configured to guide said sleeve along said shaft and abut against said stop ring to prevent dislodging of said sleeve from said chuck adapter, wherein:
said slide ring is detachably connected to and disposed within said first sleeve end,
said first sleeve end comprises a set screw to detachably connect said first sleeve end to said slide ring,
said slide ring comprises steel or plastic.

17. The self-centering drill assembly of claim 16, wherein the self-centering drill assembly comprises a plurality of said drill bits and said chuck adapters, wherein said drill bits are of different diameters smaller than said orifice in said second sleeve end and said chuck adapters are each identical to permit removable attachment of said stop ring, said slide ring, said sleeve, and said spring.
